(19) United States
(12) Patent Application Publication
(10) Pub. No.: US 2010/0089817 A1
(43) Pub. Date: Apr. 15, 2010

(54) HOLLOW FIBER, HOLLOW FIBER BUNDLE, FILTER AND METHOD FOR THE PRODUCTION OF A HOLLOW FIBER OR A HOLLOW FIBER BUNDLE

(76) Inventors: Klaus Heilmann, St. Wendel (DE); Torsten Keller, Hermeskeil (DE)

Correspondence Address: JACOBSON HOLMAN PLLC, 400 SEVENTH STREET N.W., SUITE 600, WASHINGTON, DC, 20004, US

(21) Appl. No.: 12/449,774

(22) PCT Filed: Feb. 25, 2008
(86) PCT No.: PCT/EP2008/001480

§ 371 Date: Aug. 26, 2009

(30) Foreign Application Priority Data
Feb. 26, 2007 (DE) 102007009208.5

(51) Int. Cl. B01D 69/08; D01D 5/24

(52) U.S. Cl. 210/456; 264/209.2

(57) ABSTRACT

The present invention relates to a hollow fiber made of a semipermeable membrane material, with the hollow fiber having exactly one restriction over its total length in which the inner diameter of the hollow fiber is reduced with respect to the section or sections of the hollow fiber adjoining the restriction. The present invention further relates to a hollow fiber bundle, to a filter and to a method for the manufacture of a hollow fiber or of a hollow fiber bundle.

The present invention relates to a hollow fiber made from a semipermeable membrane material, to a fiber bundle comprising hollow fibers, to a filter comprising a fiber bundle as well as to a method for the manufacture of a hollow fiber or of a hollow fiber bundle.

In dialysis, blood is continuously taken from the patient and conducted through a filter module (dialyzer) and subsequently led back to the patient in a circuit. When flowing through the filter, metabolic products which can no longer be excreted via the kidney are removed from the blood and the possibility exists to add components from the dialysis liquid to the blood via the filter as required. Such a filter module usually has a bundle of hollow fiber membranes which is encompassed in a housing. The membrane fibers are located in the housing in an elongated, more or less parallel arrangement. Connections at the housing make it possible that the blood is generally conducted from the hose lines of the blood circuit into the interior of the fiber, i.e. into the fiber hollow space, flows through it along the length and is guided at the ends of the fibers through an outlet into the continuing hose line of the blood circuit.

Furthermore, the dialysis liquid is supplied to the inner space of the housing surrounding the fibers by means of a second liquid circuit. The dialysis liquid is generally a watery liquid which flows through the interior space of the housing, for example in the direction of the fiber along the length. The housing of the filter module has corresponding connections for the supply of the dialysis liquid into the housing inner space and for the removal of the dialysis liquid from the housing inner space. The membrane fibers are thus in contact with two liquid flows, the flow of the dialysis liquid at the outer membrane wall and the blood flow at the inner membrane wall.

Components of both liquids (blood and dialysis liquid) can accordingly pass through the porous membrane structure in accordance with their size. In this context, the pore size of the membrane is decisive for the question which materials can pass through the membrane wall and which cannot. The mean pore size of a hollow fiber membrane can be influenced by the manufacturing process. Depending on the treatment process, different hollow fiber membranes of different pore sizes are required.

Membranes having a relatively small pore size are in use for dialysis processes. In these processes, primarily substances of a low to medium size are removed from the blood. Generally, molecules with a molecular weight of <500 g/mol are associated with the group of small molecules in the blood treatment process and molecules with a molecular weight ranging from 500 to 15,000 g/mol are associated with the group having a medium sized molecular size. In plasma pheresis processes, in contrast, membranes with larger pore diameters are required since here the total blood plasma also with high-molecular, large protein molecules, should be separated from the cell components of the blood. Proteins having a molecular weight of more than 15,000 g/mol count as such large molecules.

The material transport through the membrane wall can take place according to different principles from the blood side to the dialysate side or also vice versa from the dialysate side to the blood side. In this context, the transport phenomena of diffusion and convection are essentially relevant. The driving force for the diffusion is a concentration difference, i.e. the endeavor for concentration differences in liquid or gaseous systems to reach equilibrium. Particularly small molecules are involved in this concentration balance since they are comparatively movable, i.e. carry out a pronounced particle movement. Large molecules, in contrast, only carry out very small particle movements and are hardly transported through the membrane wall by diffusion.

The transmembrane transport of medium sized and large molecules can, in contrast, take place by convection. In the present case, convection is termed the flow through the membrane wall compelled by a transmembrane pressure gradient (TMP=transmembrane pressure). A pressure differential between the dialysate side and the blood side is caused by the flow rate and the flow direction of the two liquid circuits (blood and dialysis liquid).

The transmembrane filtrate flux, also called the ultrafiltration rate Q_{F}, and thus the liquid flow which crosses to the dialysate side or to the blood side is proportional to the transmembrane pressure TMP in accordance with the following relationship:

Q_{F}=UF_{coeff}·TMP

It becomes clear that the filtrate flux Q_{F} is the larger, the larger the ultrafiltration coefficients UF_{coeff} or the transmembrane pressure TMP. UF_{coeff}, in this context, is a measure for the permeability of the membrane with respect to the surface and it increases with the number of pores, the membrane surface and the size of the pores.

Membranes which have these optimized parameters are also called high flux membranes. They are called this because they permit a high transmembrane flux and thus also an optimized material transport of medium-sized and large molecules.

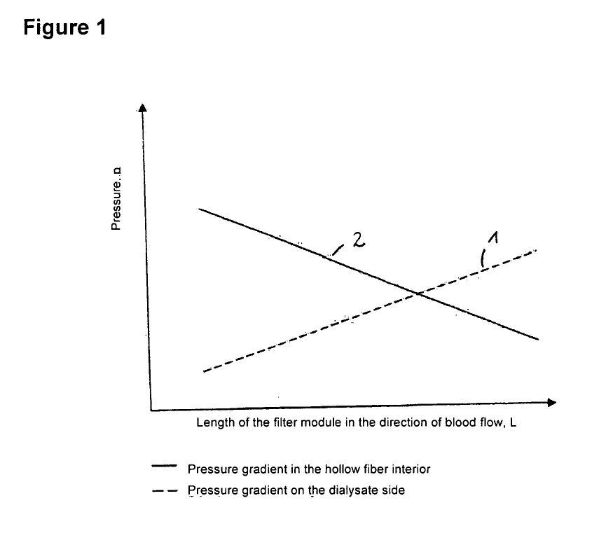

The principle of convective transport will now be explained schematically with respect to FIG. 1.

FIG. 1 shows the pressure gradient to be found in a high flux filter module on the dialysate side (line 1) and in the interior of the hollow fibers (line 2) over the length of the hollow fibers in the flow direction of the blood.

When the blood enters into the filter module or into the hollow fibers, there is initially a high pressure on the blood side which reduces in a continuous and linear manner up to the blood outlet. The pressure on the dialysate side shows an opposite behavior since, in the case shown here, the flow directions are reversed, i.e. the filter is operated in counterflow. In such a filter module, the area which is disposed between the straight line of the pressure gradient on the blood side and the straight line of the pressure gradient on the dialysate side in a longitudinal section L₂-L₁ is a measure for the TMP. The larger the spacing of the two straight lines, the larger the transmembrane pressure at the indicated position. It can be recognized in FIG. 1 that the area in such constant longitudinal sections becomes smaller as the length increases, i.e. with an increasing spacing from the end or the start of the filter, is zero at the intersection of the straight liens and increases again with a larger length. It follows from this that the TMP reduces continuously, viewed from the blood inlet (shown at the left in FIG. 1). In the region in which the pressure on the blood side is larger than the pressure on the dialysate side, a convective transport first takes place from the blood side to the dialysate side. After the intersection of the pressure straight lines, the TMP increases again; however, a convective material transport now takes place from the dialysate side to the blood side since the pressure on the dialysate side is larger than the pressure on the blood side.

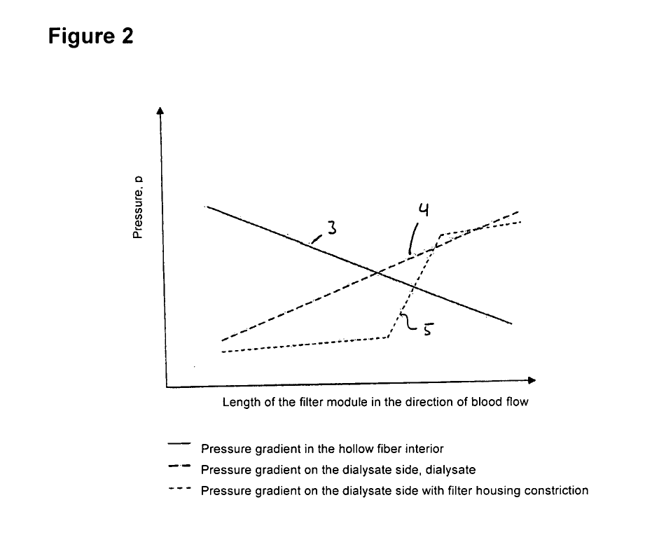

The challenge exists with such filter modules to increase the TMP and thus also the transmembrane flux. One possibility consists of installing a flux barrier in the filter module on the dialysate side. Such a procedure is known from U.S. Pat. No. 5,730,712. The pressure gradients in such a module are shown schematically in FIG. 2.

As also in FIG. 1, the solid straight line (line 3) characterizes the pressure gradient on the blood side, while the dashed line 4 shows the pressure gradient on the dialysate side of an unchanged filter module. If a filter with a flux barrier on the dialysate side is now used, the dashed line 5 results. As can be seen clearly from FIG. 2, the flux barrier has the effect that the pressure on the dialysate side, viewed in the dialysate flow direction (from right to left in FIG. 2) first falls comparatively weakly with respect to the unmodified filter module; a strong pressure drop takes place in the region of the flux barrier. The pressure on the dialysate side only falls a little downstream of the flux barrier, i.e. the slope of the pressure gradient over the length of the filter module is lower than in the region of the flux barrier on the dialysate side.

The installation of the flux barrier has the result that the amount of the enclosed surface between the pressure gradient on the blood side and the pressure gradient on the dialysate side is larger than with the filter module not having such a flux barrier, as can clearly be seen from FIG. 2. A larger convective transmembrane transport therefore results than with a filter module without the said flux barrier. The flux resistance on the dialysate side thus effects an increase in size of the transmembrane flux from the blood side to the dialysate side. This principle has been examined by Ronco et al. We refer to the article C. Ronco et al.: “Enhancement of convective transport by internal filtration in a modified experimental hemodialyzer”; Kidney International, Vol. 54; 1998, p. 979 ff., from which it results that the removal of medium-sized molecules, vitamin B12 and insulin could be increased considerably due to the reduction in the flow cross-section on the dialysate side. This principle is also the subject of EP 1 433 490, EP 1 344 542 and WO 2006/024902.

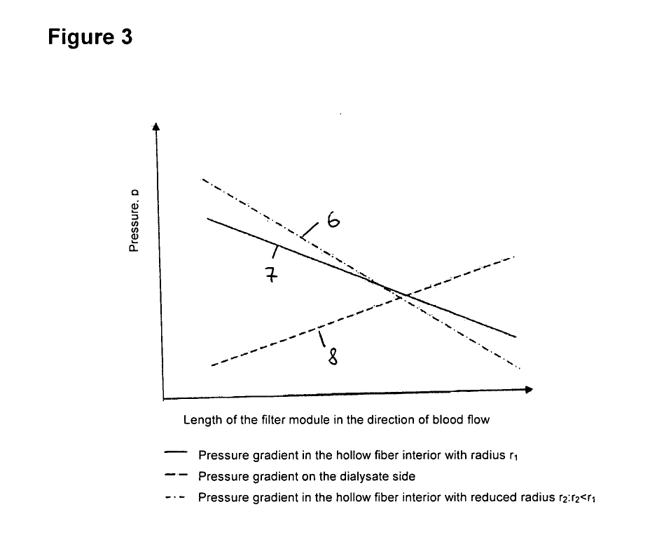

It is furthermore known to increase the transmembrane pressure in that hollow fibers with a small inner diameter are used. FIG. 3 shows the influence of the inner fiber diameter on the inner fiber pressure over the fiber length. In this connection, in accordance with Hagen-Poiseuille's Law, the pressure drop increases as the capillary radius decreases. It results from this that the pressure gradient inside a hollow fiber (FIG. 3, line 6) with a smaller diameter is steeper than with hollow fibers with a larger diameter in comparison (FIG. 3, line 7). Line 8 characterizes the pressure gradient on the dialysate side. It results from FIG. 3 that the area in a longitudinal section L₂-L₁ between the respective straight lines of the pressure gradient on the dialysate side and on the blood side, and thus the transmembrane pressure, increases by a reduction in the hollow fiber radius.

Ronco et al. also examined this principle with respect to TMP increase. We refer to Ronco et al.: “Effects of a reduced inner diameter of hollow fibers in hemodialyzers”; Kidney International, Vol. 58; 2000, p. 809 ff. In the comparative examination of hollow fiber membranes with 200 μm and 185 μm inner diameter, an improved removal of the medium-sized molecules, vitamin B12 and insulin was found for the membrane with a lower inner diameter.

The reduction in the fiber inner diameter, however, results in problems. On the introduction of blood into the very small fiber openings, the blood cells are highly accelerated in this flow section and large friction arises between the blood cells and the material of the filter module. Blood cells can be destroyed under certain circumstances. The inner radius can therefore not be increased as desired. Commercial filter modules have hollow fiber radii inter alia of 185 μm. Smaller radii are, however, to be classified as unfavorable in extracorporeal blood treatment.

It is therefore an object of the present invention to provide a filter in which the named disadvantage of damage to or destruction of blood cells does not occur or only occurs to a lesser degree and in which nevertheless a pronounced convective transport can be realized over the membrane of the hollow fibers.

This object is solved by a hollow fiber having the features of claim 1, by a fiber bundle in accordance with claim 9, by a filter in accordance with claim 10 and by a method having the features of claim 15.

Provision is made in accordance with the invention for a hollow fiber to be provided which has precisely one restriction over its total length in which the inner diameter of the hollow fiber is reduced with respect to the section or sections of the hollow fibers adjoining the restriction. The hollow fiber can have a constant inner diameter or also a variable inner diameter in the region of the restriction. In accordance with the present invention, it is possible to provide a hollow fiber membrane which makes it possible to set a comparatively high TMP in blood purifying modules with a gentle treatment of the blood and, associated therewith, an improved convective transport of medium-sized and optionally also large molecules.

The restriction can extend, for example, over a longitudinal section of the hollow fiber, with the longitudinal section being able to amount to less than 5%, between 5% and 10%, between 10% and 15%, between 15% and 25% or more than 25% of the total length of the fiber.

It is also conceivable that the inner diameter of the hollow fiber increases up to its ends at both sides of the restriction, with the restriction also being able to be arranged at the centre of the length of the hollow fiber or also offset thereto.

The inner diameter of the hollow fiber can amount to less than 40%, between 40% and 50%, between 50% and 80% or more than 80% of the inner diameter of the hollow fiber in the section or sections of the hollow fiber not formed by the restriction.

As stated above, the restriction can extend over a longitudinal section of the hollow fiber and have a constant inner diameter. It is also conceivable that the restriction extends over a longitudinal section of the hollow fiber and has an inner diameter which, for example, first decreases and then increases again.

The transition from the region or regions adjacent to the restriction can be configured in a stepped manner or also constantly.

In the case of restriction points in the fiber, the problem basically arises that flowing blood is accelerated to a higher flow speed in the restriction. The frictional forces at the fiber wall also increase and there is the risk of hemolysis. It is therefore conceivable that the restriction extends over a longitudinal section of the hollow fiber and that one or two transition regions exist between the restriction and regions of the hollow fiber not formed by the restriction. These transition regions can have a length amounting to between 5% and 20% of the length of the said longitudinal section. If the transition region from a larger inner diameter to a smaller diameter on a hollow fiber is only present on a very short section, a high blood flow acceleration and high frictional values are also found. It is therefore advantageous for this transition region to take place uniformly over a certain sectional length. Sectional lengths for the transition region are preferably not below 5% of the total constriction passage. Values of 10%, 15% or 20% are, however, also possible depending on the total length of the constriction passage.

Furthermore, the diameter can reduce continually initially over the total constriction passage down to a minimum value and subsequently increase again up to the original inner diameter. Generally, it is advantageous for the intended use of the fiber in accordance with the invention in blood treatment therapies for the constriction point to be arranged symmetrically in its geometry to the position with the smallest inner diameter. Asymmetric geometries are, however, equally suitable.

The inner diameter of the constriction is oriented on the blood treatment method for which the fiber in accordance with the invention is provided. Hollow fiber membranes which are used e.g. for plasma pheresis have a diameter in the region of 320 μm. With such processes, it is expedient to select a more pronounced constriction of approximately 50% or more. A preferred fiber in accordance with the invention for this method has an inner diameter of 150 μm at the constricted position.

With hollow fibers designed for dialysis, the conventional inner diameter here is approximately 200 μm. A preferred embodiment of a hollow fiber in accordance with the invention for dialysis likewise has an inner diameter of approximately 150 μm here. The relative constriction here amounts to 25%.

The absolute minimal value of the inner diameter is subject to certain limitations. With too low an inner diameter, the blood is accelerated too much along the restricted passage and there is the risk that blood cells can be destroyed by friction with the fiber inner wall and that hemolysis reactions can occur. The narrowest region, that is the region of the most pronounced constriction, for fibers used in extracorporeal blood purification processes preferably lies in the region of 150 μm, depending on the blood flow rate. However, smaller inner diameters of the restriction can also be selected on an adaptation of the blood flow rate or on other parameters of the blood treatment.

The position of the restriction between the ends of the hollow fiber is variable in dependence on the demand. Typical fiber bundle lengths used in filter modules for dialysis lie between 24 and 28 cm. The constriction point can be at different positions within these dimensions depending on the treatment method. The restriction is preferably located in the middle section of the fiber bundle length. However, it can also be desired that the convective transport should take place decisively only from the blood side to the dialysate side. In such treatment applications, the constriction point of the fiber bundle in the filter module will preferably lie in the last third, when viewed in the direction of the blood flow. In the reverse case, it can be desired that the convective transport takes place decisively from the dialysate side to the blood side. In such applications, the constriction point is preferably in the first third of the fiber bundle in the filter module, again when viewed in the direction of the blood flow.

The present invention furthermore relates to a fiber bundle having a plurality of hollow fibers in accordance with one of the claims 1 to 8.

The invention furthermore relates to a filter module having a filter housing and at least one fiber bundle which is arranged in the filter housing and which is characterized in that the fiber bundle is a fiber bundle in accordance with claim 9.

It is particularly advantageous for the desired increase in the transmembrane pressure for the hollow fiber in accordance with the invention or the hollow fiber bundle in accordance with the invention to be used in a filter module having a flow restriction on the dialysate side. Provision can accordingly be made for flow restriction means to be provided by which the area of the region surrounding the hollow fibers of the fiber bundle within the filter housing, i.e. the flow cross-section on the dialysate side, is reduced.

The flow restriction means can be configured as a restriction of the filter housing in which the inner diameter of the filter housing is reduced with respect to the section or sections of the housing adjacent to the restriction.

It is also conceivable that the flow restriction means are configured as a ring which is arranged within the filter housing and surrounds the fiber bundle. A reduction in the flow cross-section on the dialysate side results in this manner, too.

The flow restriction means can, for example, also be a swellable substance which swells up on contact with a medium, preferably on contact with the dialysis liquid, flowing through the space surrounding the fiber bundle.

The present invention furthermore relates to a method for the manufacture of a hollow fiber in accordance with one of the claims 1 to 8 or for the manufacture of a hollow fiber bundle in accordance with claim 9, with the method comprising the winding up of the manufactured hollow fibers or of the manufactured hollow fiber bundle onto a winding device, in particular onto a reel.

A manufacturing method of this type for hollow fiber membranes is sufficiently known from the prior art. The manufacture can take place, for example, by a wet spinning method. In this process, a polymer solution is extruded via a ring nozzle and introduced into a coagulation bath. An inner precipitating agent is simultaneously co-extruded through an inner opening of the nozzle on the extrusion of the polymer solution so that a hollow polymer solution thread filled with a precipitating agent is present overall. A porous hollow fiber membrane is created from the polymer solution thread by a phase inversion process and is removed via a roller system and conducted through a plurality of flushing, treatment and drying phases. Finally, the fiber is wound onto a winding device, preferably onto a reel. Reference is made to EP 0 750 936 B1, EP 1 547 628 A1 and EP 0 543 355 B1 with respect to a manufacturing process of this type.

To produce a constriction or a variation of the inner diameter, there is the possibility of lowering the extrusion pressure of the inner precipitating agent for a brief period during the extrusion of the polymer solution. Alternatively, it is also possible to vary the removal speed of the roller system with which the polymer thread is removed. On a short-term increase in the removal speed, the extruded polymer solution thread is pulled lengthwise and necessarily reduces its inner diameter in so doing. A further method for the reduction of the inner flow cross-section of a hollow fiber consists of processing the fiber by stamping or fluted rolls such that the fibers are compressed at this position due to the external pressure the rolls exert on the fiber. The inner cross-section is thereby reduced.

It is known from DE 28 42 958 A1 to achieve a variation of the inner diameter by periodical pressure variations during the extrusion of the spinning mass or of the inner precipitating agent. The fiber is thus given a wave-like structure in the longitudinal section. Similar processes are also described in U.S. Pat. No. 4,380,520 and U.S. Pat. No. 4,291,096. Fibers with structures of this type should avoid a mutual adhesion of the fibers in the fiber bundle during the dialysis process to thus improve a transmembrane material transfer. An increase in the transmembrane pressure can, however, not be observed with fibers of this type.

Provision is made in accordance with the invention for a restriction of the hollow fiber to be produced in which the inner diameter of the hollow fiber is reduced with respect to the section or sections adjoining the restriction and for the time at which the winding device adopts a certain position to be synchronized with the time of the production of the restriction of the hollow fiber such that the restriction is located at a predetermined position relative to the winding up direction in the wound up state of the hollow fiber. It is thus conceivable, for example, to synchronize the reel position with the variation of the precipitating agent pressure, with the variation of the removal speed or with the action of the stamping and fluted rolls.

It is possible to position a proximity switch in a stationary manner at the periphery of the reel, for example, to generate a synchronization signal. The proximity switch delivers a signal on passing through a reel arm through a predetermined position. The signal is delivered to a process control unit. Subsequent to this, influence is exerted by the process control unit on, for example, the precipitating agent pressure, the removal speed or the stamping rolls. Consequently, a restriction arises in the extruded polymer solution hollow thread.

In a further aspect of the invention, provision is made for the wind-up device to be a reel which has at least one reel segment and for the synchronization of the production of the restriction with the position of the reel to be carried out such that the restrictions each lie centrally in the reel segments. It is also conceivable for the restrictions each not to be located centrally in the reel segments, but offset thereto. Accordingly, it is also possible that the restrictions are not placed centrally or symmetrically to the reel segment center. It is possible to vary the position of the restrictions within a reel segment by extending or reducing the dead time duration, i.e. the time duration the restriction requires for the passage through the path between the extrusion nozzle or between the unit for the manufacture of the restriction and the desired position on the reel wheel. It is thereby possible to isolate hollow fiber bundles whose restriction is not to be found centrally in the bundle. The position of the restrictions of a fiber bundle in a filter module can thus be predetermined without restriction. As stated above, depending on the blood treatment method, it can be desirable for the fiber bundle restriction to lie in the first, second or third thirds of the filter module, when viewed in the direction of blood flow. It is also possible in special cases to select smaller sections in which the fiber bundle restriction should lie.

Provision is made in a further aspect of the invention for the wind-up device to be a reel which has at least one reel segment and for the synchronization of the time of the production of the restriction with the time in which the reel runs through a specific position to take place such that more than one restriction of the hollow fibers is present per reel segment. It is thus possible to gain not only one fiber bundle, but also more than one fiber bundle from one reel segment by means of the method in accordance with the invention. This is above all relevant for reels which have a smaller number of segments, e.g. two to six segments, and which have larger radii of the reel arms. Only two or more signals have to be transmitted after the passing through of a reel segment and before the passing through of the next reel segment so that the production of the restrictions can be synchronized with the position of the reel arms.

The number of the reel segments is generally not restricted for the carrying out of the method in accordance with the invention. Reels having eleven, nine or seven segments can be used as equally as reels having three or five segments.

Further details and advantages of the invention will be explained in more detail with reference to an embodiment shown in the drawing. There are shown:

FIG. 1: the pressure gradient in a schematic representation on the blood side and on the dialysate side over the length of the filter module in the direction of blood flow;

FIG. 2: the pressure gradient in a schematic representation on the blood side and on the dialysate side over the length of the filter module in the direction of blood flow with and without a reduction in the flow cross-section on the dialysate side;

FIG. 3: the pressure gradient in a schematic representation on the blood side and on the dialysate side over the length of the filter module in the direction of blood flow for different hollow fiber inner diameters;

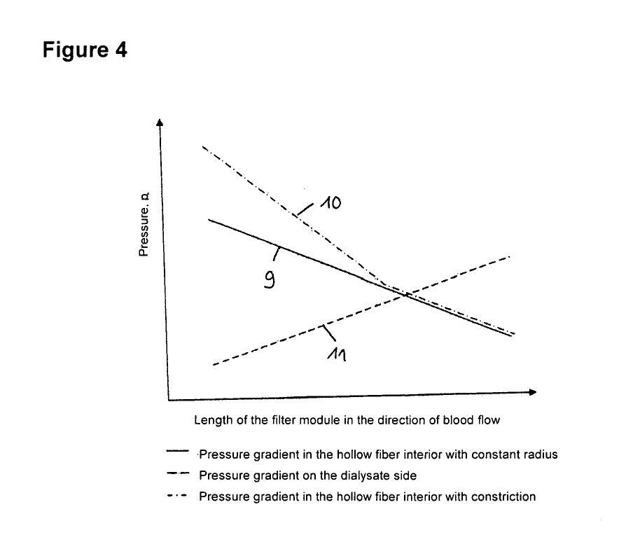

FIG. 4: the pressure gradient in a schematic representation on the blood side and on the dialysate side over the length of the filter module in the direction of blood flow with and without a reduction in the inner diameter of the hollow fibers;

FIG. 5: a schematic representation of the components of the manufacturing process of hollow fibers and hollow fiber bundles respectively;

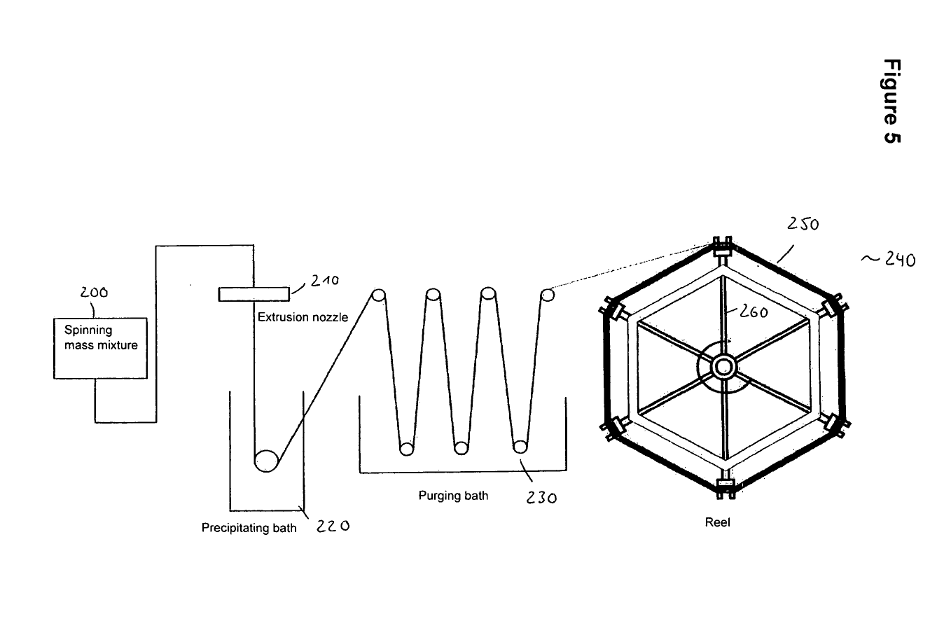

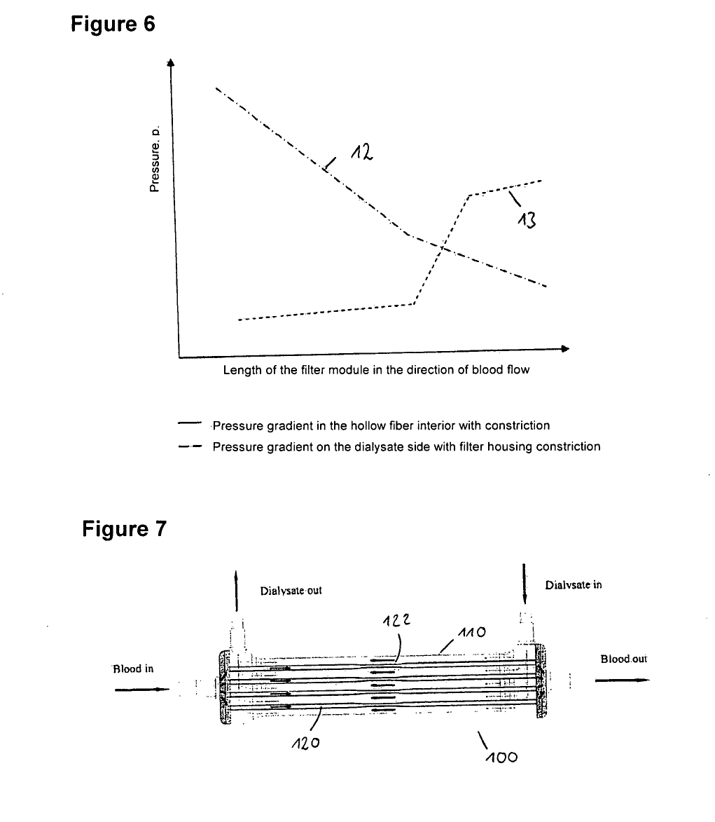

FIG. 6: the pressure gradient in a schematic representation on the blood side and on the dialysate side over the length of the filter module in the direction of blood flow with a reduction in the inner diameter of the hollow fibers and with a reduction in the flow cross-section on the dialysate side;

FIG. 7: a schematic representation of a filter in accordance with the invention with a reduction of the inner diameter of the hollow fibers in the region of a restriction;

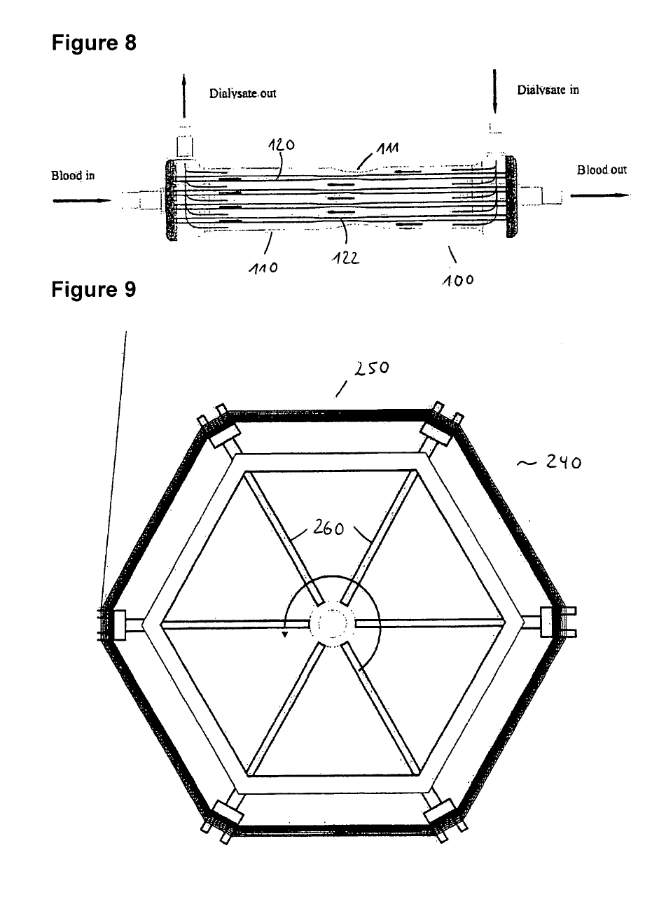

FIG. 8: a schematic representation of a filter in accordance with the invention with a reduction of the inner diameter of the hollow fibers in the region of a restriction as well as with a reduction in the inner diameter of the filter housing; and

FIG. 9: a schematic representation of a reel wheel.

FIG. 4 shows the pressure gradient (line 9) on the blood side of a hollow fiber, which has a constant inner diameter over its total length, over the length of the filter module or of the hollow fiber in the direction of blood flow. Line 10 in FIG. 4 shows the pressure gradient in the interior of a hollow fiber in accordance with the invention which has a restriction in which the inner diameter of the hollow fiber is reduced with respect to the restriction of adjacent regions. Due to the restriction of the hollow fiber, with a given flow rate in the embodiment shown in FIG. 4, there is a higher pressure at the fiber inlet opening than with a hollow fiber without restriction. As can be seen from the curve development in accordance with line 10, the pressure only decreases slowly, viewed relatively, along the fiber in the direction of flow up to the restriction, drops steeply in the region of the restriction and with a gradient downstream of the restriction which is between the gradient upstream and the gradient in the region of the restriction. Line 11, finally, shows the pressure gradient on the dialysate side, likewise in the direction of blood flow, with blood and the dialysis liquid flowing through the filter in counterflow.

The pressure conditions which are to be found in a filter module on the blood side and on the dialysate side, wherein furthermore a constriction of the filter housing, i.e. a regional reduction in the flow cross-section on the dialysate side, results, are shown in FIG. 6, with the line 12 showing the pressure gradient on the blood side and the line 13 showing the pressure gradient on the dialysate side, in each case in the direction of blood flow.

As results on a comparison of the representations of FIG. 2 and of FIG. 4 and FIG. 6, the pressure curves for the dialysate and the blood up to the restriction of the fiber bundle are further apart than for the case that neither the hollow fibers nor the filter housing has a restriction. A particularly large spacing between the two pressure curves results for the case that the hollow fibers have a restriction and that a filter housing constriction or another constriction of the flow cross-section is present on the dialysate side, as can be seen from FIG. 6.

FIG. 7 shows a dialyzer (filter) 100 in accordance with the invention having a housing 110 and hollow fibers 120 which are arranged therein parallel to the longitudinal direction of the housing and which are combined to form a bundle. The end regions of the hollow fibers 120 are located in molding compounds which sealingly contact the inner side of the housing 110. As can further be seen from FIG. 7, the fiber inner spaces are flowed through by blood from left to right in accordance with FIG. 7 and the dialysate space, which surrounds the fibers 120, by dialysis liquid from right to left, i.e. in the counterflow. With respect to the total length of the hollow fibers, they have a restriction 122 approximately centrally which extends over a specific longitudinal section of the hollow fibers 120. The pressure gradient resulting on the use of a filter 100 in accordance with FIG. 7 is reproduced by the lines 10 and 11 in FIG. 4.

FIG. 8 shows a dialyzer (filter) 100) in accordance with the invention which differs from the dialyzer in accordance with FIG. 7 in that the housing 110 has a constriction 111 in which the housing inner diameter is reduced with respect to the further sections of the housing. A particularly high transmembrane pressure results overall due to the arrangement. The flow restriction on the dialysis side is shown in this case for the example of a constriction of the filter housing. This representation reproduces such a filter module only schematically. As stated above, further flow restriction devices on the dialysis side can also be imagined. These can e.g. be a ring which surrounds the fiber bundle and is disposed in the interior of a cylindrical filter housing. It can, however, also be a swellable substance into which fibers are embedded and which swell up in contact with the dialysate and cause a pressure jump on the dialysate side by flow restriction. Influence is taken on the pressure gradient on the dialysate side by this measure such as results from a comparison of the lines 4 and 5 in FIG. 2. The pressure gradient of the arrangement in accordance with FIG. 8 is shown in FIG. 6.

The position of the restriction in the fiber bundle and of the flow restriction on the dialysate side is not restricted to the embodiment shown in FIG. 8. Both restrictions can also be located in the third of the filter module, when viewed in the direction of the blood flow. The TMP before the fiber bundle restriction is thereby further increased and the convective material transport from the blood side to the dialysate side is increased. However, the fiber restriction and the dialysate flow restriction can equally be disposed in the first third of the filter module. With such an arrangement, the convective material transport is conveyed from the dialysate side to the blood side. Further relative positions of the fiber restriction to the dialysate flow restriction are possible.

FIG. 5 shows an arrangement for the manufacture of a hollow fiber or of a hollow fiber bundle in accordance with the invention. The spin mass mixture is marked by the reference numeral 200. A polymer solution thread is produced by means of the extrusion nozzle 210. The nozzle 210 is a ring nozzle which has a further nozzle in a region bounded thereby by means of which precipitating agent is introduced into the interior of the polymer solution thread. The inner diameter of the polymer solution thread or of the hollow thread can be modified, for example by changing the precipitating agent pressure, by changing the removal speed at which the thread is removed from the nozzle 210 or by rolls not shown here, so that a restriction is present with respect to the finished hollow fiber in which the inner diameter of the hollow fiber is reduced.

The hollow fiber with the restriction is transported by the roller system of the spinning unit through the precipitation bath 220 and the washing or rinsing bath 230.

Provision is made in accordance with the invention for the hollow fiber membrane to be wound up onto the reel 240 such that the restriction is placed in a reel segment 250 at the desired point, e.g. offset centrally or toward the center. To ensure this, a signal of a proximity switch is generated on the passing through of a reel arm 260. Since the running time (dead time) of the restriction from the extrusion nozzle or stamping roll up to the center of the desired position of the reel segment 250 is known, the rotation speed of the reel 240 can be set such that the restriction comes to lie at the desired position in the reel segment and is thus also located at the desired position in the fiber bundle. The conveying speed of the thread can also be set with a constant rotation speed of the reel such that the restriction is disposed at the desired position.

Further optimizations which result per se for the skilled person from the shown solution approach are to be noted. For example, the effective reel periphery increases due to the gradually placed hollow fibers. It is thereby necessary to slow down the rotation speed of the reel with an increasing duration of the spinning process. The dead time must also be adapted in the course of the spinning process.

The fiber bundle with a restriction arranged in accordance with the invention in the fibers can then be cut out of a reel segment and is available for further processing to a filter module.

FIG. 9 finally shows a reel wheel 240 having reel arms 260 and reel segments 250 bounded by their ends in an enlarged representation.

All Figures are only to be understood very schematically. They are only intended to show that back pressure builds up before a restriction in the flow passage in accordance with the embodiments shown and the pressure drop in the flow direction then takes place more slowly than without a restriction. There is a rapid pressure drop at the restriction. The flow resistances after the restriction should preferably be the same, with or without restriction. The position of the pressure curves for the hollow fiber inner side and the dialysate side relative to one another are purely schematic. However, they are preferably disposed relative to one another such that, as shown in FIG. 6, surfaces enclosed by the two curves arise. The magnitude of the surface is a measure for the size of the convective transport through the membrane wall. The block arrows in accordance with FIG. 6 indicate the direction in which the convective transport takes place in accordance with the transmembrane pressure difference.

The gradients in the individual sections of the pressure curves are likewise only to be understood schematically.

1. A hollow fiber made of a semipermeable membrane material, characterized in that the hollow fiber has exactly one restriction over its total length in which the inner diameter of the hollow fiber is reduced with respect to the section or sections of the hollow fibers adjoining the restriction.

2. A hollow fiber in accordance with claim 1, wherein the restriction extends over a longitudinal section of the hollow fiber, with the longitudinal section amounting to less than 5%, between 5% and 10%, between 10% and 15%, between 15% and 25% or more than 25% of the total length of the fiber.

3. A hollow fiber in accordance with claim 1, wherein the inner diameter of the hollow fiber in the restriction amounts to less than 40%, between 40% and 50%, between 50% and 80% or more than 80% of the inner diameter of the hollow fiber in the section or sections of the hollow fiber not formed by the restriction.

4. A hollow fiber in accordance with claim 1, wherein the restriction extends over a longitudinal section of the hollow fiber and has a constant inner diameter.

5. A hollow fiber in accordance with claim 1, wherein the restriction extends over a longitudinal section of the hollow fiber and has a first decreasing and then again increasing inner diameter.

6. A hollow fiber in accordance with claim 1, wherein the transition from the region or regions adjacent to the restriction to the restriction is stepped or constant.

7. A hollow fiber in accordance with claim 1, wherein the restriction extends over a longitudinal section of the hollow fiber; wherein one or two transitional regions exist between the restriction and regions of the hollow fiber not formed by the restriction; and wherein the length of the transition region amounts to between 5% and 20% of the length of the said longitudinal section.

8. A hollow fiber in accordance with claim 1, wherein the restriction has a point of minimal inner diameter of the hollow fiber; and wherein the restriction is symmetrical to this point.

9. A fiber bundle, characterized in that the fiber bundle has a plurality of hollow fibers in accordance with claim 1.

10. A filter comprising a filter housing and at least one fiber bundle arranged in the filter housing, characterized in that the fiber bundle is a fiber bundle in accordance with claim 9.

11. A filter in accordance with claim 10, wherein flow restriction means are provided by which the surface of the region surrounding the hollow fibers of the fiber bundle is reduced within the filter housing.

12. A filter in accordance with claim 11, wherein the flow restriction means is configured as a restriction of the filter housing in which the inner diameter of the filter housing is reduced with respect to the section or sections of the housing adjoining the restriction.

13. A filter in accordance with claim 11, wherein the flow restriction means are configured as a ring which is arranged within the filter housing and which surrounds the fiber bundle.

14. A filter in accordance with claim 11, wherein the flow restriction means are configured as a swellable substance which swell up on contact with a medium which flows through the space surrounding the fiber bundle.

15. A method for the manufacture of a hollow fiber in accordance with claim 1, wherein the method comprises the winding up of the manufactured hollow fiber onto a wind-up device, in particular onto a reel, characterized in that a restriction of the hollow fiber is produced in which the inner diameter of the hollow fiber is reduced with respect to the section or sections of the hollow fiber adjoining the restriction; and in that the position of the wind-up device is synchronized with the production of the restriction of the hollow fiber such that the restriction is located at a predetermined position relative to the wind-up device.

16. A method in accordance with claim 15, wherein, on the reaching of at least one predetermined position of the wind-up device, in particular of a reel arm of a reel, a signal is produced; and wherein the production of the restriction is carried out on the basis of the signal.

17. A method in accordance with claim 15, wherein the wind-up device is a reel which has at least one reel segment; and wherein the synchronization of the production of the restriction with the position of the reel is carried out such that the restrictions each lie centrally in the reel segments.

18. A method in accordance with claim 15, wherein the wind-up device is a reel which has at least one reel segment; and wherein the synchronization of the production of the restriction with the position of the reel is carried out such that the restrictions each do not lie centrally in the reel segments.

19. A method in accordance with claim 18, wherein the synchronization of the production of the restriction with the position of the reel is carried out such that restrictions each lie in the first, second or third of the total length of the manufactured hollow fibers.

20. A method in accordance with claim 15, wherein the wind-up device is a reel which has at least one reel segment; and wherein the synchronization of the production of the restriction with the position of the reel is carried out such that more than one restriction of the hollow fibers is present per reel segment.

21. A method in accordance with claim 15, wherein the restriction of the hollow fiber is produced in that the precipitating agent pressure of the precipitating agent located in the interior of the polymer solution thread from which the hollow fiber is formed is temporarily reduced; wherein the removal speed at which the polymer solution thread from which the hollow fiber is formed is removed is temporarily increased; or wherein stamping rolls and/or fluted rolls act from outside onto the polymer solution thread or the hollow fibers formed therefrom.
